(19) United States
(12) Patent Application Publication
(10) Pub. No.: US 2020/0070624 A1
(43) Pub. Date: Mar. 5, 2020

(54) VEHICLE AIR-CONDITIONING DEVICE

(71) Applicant: MITSUBISHI HEAVY INDUSTRIES THERMAL SYSTEMS, LTD., Tokyo (JP)

(72) Inventor: Noriyuki CHIKAGAWA, Tokyo (JP)

(73) Assignee: MITSUBISHI HEAVY INDUSTRIES THERMAL SYSTEMS, LTD., Tokyo (JP)

(21) Appl. No.: 16/609,867

(22) PCT Filed: May 10, 2018
(86) PCT No.: PCT/JP2018/018106

§ 371 Date: Oct. 31, 2019

(30) Foreign Application Priority Data
May 30, 2017 (JP) 2017-107108

(51) Int. Cl. B60H 1/00

(52) U.S. Cl. CPC B60H 1/00671; B60H 1/00328

(57) ABSTRACT

A rear-side flow passage section (17) includes a rear-side duct (19), a first communication path (21), a second communication path (22), a first damper (23), and a second damper (24). The rear-side duct (19) extends from a downstream side of the heater core (15) to a rear side of a vehicle cabin. The first communication path (21) communicates a downstream side of the evaporator (14) and a front-side flow passage section with each other. The second communication path (22) communicates a downstream side of the evaporator (14) and a downstream side of the heater core (15) with each other. The first damper (23) is configured to allow an airflow to be selectively introduced into the first communication path (21) or the second communication path (22). The second damper (24) is configured to change a communication state between a downstream opening (15b) of the heater core (15), the rear-side duct (19), and the second communication path (22).

### TECHNICAL FIELD

The present invention relates to a vehicle air-conditioning device mounted in a vehicle.

This application claims priority based on Japanese Patent Application No. 2017-107108 filed in Japan on May 30, 2017, of which contents are incorporated herein by reference.

### BACKGROUND ART

The following vehicle air-conditioning device has been known. The vehicle air-conditioning device includes an evaporator, and a heater core disposed on a downstream side of the evaporator. An airflow being a mixture of cool air from the evaporator and warm air from the heater core is blown out into a vehicle cabin.

In a vehicle air-conditioning device in Patent Document 1, each of a flow rate of warm air and a flow rate of cool air is adjusted by a damper or the like, and a mixing rate of warm air and cool air is thereby adjusted. An airflow being a mixture of warm air and cool air is blown out through a foot part and a face part on a front side of a vehicle cabin, and through a foot part and a face part on a rear side of the vehicle cabin. Air conditioning of a vehicle cabin is implemented with airflow blown out through these foot parts and face parts. Patent Document 1 describes a configuration in which such an airflow being a mixture of warm air and cool air is blown out to both the front side of the vehicle cabin and the rear side of the vehicle cabin. Therefore, a temperature and a flow rate of an airflow to be blown out to the rear side of the vehicle cabin cannot be independently adjusted.

In a vehicle air-conditioning device in Patent Document 2, an airflow passage, where heat exchange is performed, is partitioned into four flow passages by partition plates. These airflow passages where heat exchange is performed are independently provided for four respective seats on the right and left sides on the front side of the vehicle cabin and the right and left sides on the rear side. In Patent Document 2, owing to the above-described configuration, a temperature and a flow rate of an airflow to be blown out to the rear side can be independently adjusted.

### CITATION LIST

### Patent Document

Patent Document 1: JP 2011-131889 A

Patent Document 2: JP 2010-162946 A

### SUMMARY OF INVENTION

### Technical Problem

However, the vehicle air-conditioning device in Patent Document 2 has a configuration in which an airflow passage where heat exchange is performed is partitioned into a plurality of sections to be independent of each other, such that an airflow is caused to blow out to the right and left sides on the front side of the vehicle cabin and the right and left sides on the rear side of the vehicle cabin. Therefore, when a flow passage on the rear side is closed to cause an airflow to be blown out to the front side of the vehicle cabin, the flow passage on the rear side is merely a dead space. Only an airflow subjected to heat exchange in a part of the flow passages out of the plurality of partitioned airflow passages is blown out into the vehicle cabin.

When a flow passage on the rear side is closed as described above, a flow rate and heat to be blown out to the entire vehicle cabin is significantly reduced. Therefore, efficiency is low when air conditioning is implemented in the entire vehicle cabin while air conditioning is implemented more on the front side of the vehicle cabin. For example, it takes time to bring the entire vehicle cabin to a comfortable temperature when the entire vehicle cabin is at a low temperature and thus the entire vehicle cabin is warmed with the front side of the vehicle cabin being warmed more, and when the entire vehicle cabin is at a high temperature and thus the entire vehicle cabin is cooled with the front side of the vehicle cabin being cooled more.

The present invention has an object to provide a vehicle air-conditioning device capable of efficiently implementing air conditioning in the entire vehicle cabin.

### Solution to Problem

According to a first aspect of the present invention, a vehicle air-conditioning device includes an evaporator, a heater core, and a front-side flow passage section and a rear-side flow passage section. The heater core is disposed on a downstream side of the evaporator. The front-side flow passage section allows an airflow to be blown out to a front side of a vehicle cabin. The flow of air includes both cool air from the evaporator and warm air from the heater core. The rear-side flow passage section is provided independently of the front-side flow passage section and is configured to allow the flow of air to be blown out to a rear side of the vehicle cabin. The rear-side flow passage section includes a rear-side duct, a first communication path, a second communication path, a first damper, and a second damper. The rear-side duct extends from a downstream side of the heater core to the rear side of the vehicle cabin. The first communication path communicates a downstream side of the evaporator and the front-side flow passage section with each other. The second communication path communicates a downstream side of the evaporator and a downstream side of the heater core with each other. The first damper is configured to open and close the first communication path to allow an airflow to be selectively introduced into the first communication path or the second communication path. The second damper is configured to change a communication state between a downstream opening of the heater core, the rear-side duct, and the second communication path.

In the first aspect, the first damper that opens and closes the first communication path, and the second damper that changes a communication state between the downstream opening of the heater core, the rear-side duct, and the second communication path are included. Therefore, when the first communication path is closed by the first damper, cool air from a downstream side of the evaporator does not pass through the first communication path to flow toward the front-side flow passage section, but passes through the second communication path to flow toward the rear-side duct extending from a downstream side of the heater core. In this case, when a degree of opening of the downstream opening of the heater core, a degree of opening of the rear-side duct, and a degree of opening of the second communication path are adjusted by the second damper, an airflow, which is a mixture of cool air from the second communication path and warm air from the heater core, can be blown out to the rear side of the vehicle cabin through the rear-side duct. For example, when a degree of opening of the second communication path is reduced and a degree of opening of the downstream opening of the heater core is increased by the second damper, an airflow at higher temperature can be sent into the rear side of the vehicle cabin. Further, when a degree of opening of the second communication path is increased and a degree of opening of the downstream opening of the heater core is reduced by the second damper, an airflow at lower temperature can be sent into the rear side of the vehicle cabin. Specifically, changing a mixing rate of cool air and warm air by the second damper enables temperature control of an airflow to be sent into the rear side of the vehicle cabin.

When the first communication path is opened by the first damper, cool air from a downstream side of the evaporator passes through the first communication path to flow toward the front-side flow passage section. In this case, when the rear-side duct is closed by the second damper, warm air from the downstream opening of the heater core passes through the second communication path to flow into the first communication path. Therefore, warm air can be caused to flow into the front-side flow passage section. As a result, even when the rear-side duct is closed by the second damper so as not to allow an airflow to be supplied to the rear side of the vehicle cabin, a dead space is not generated in the rear-side flow passage section, and a pressure loss, which may be caused due to such a dead space, is not caused.

According to a second aspect of the present invention, the vehicle air-conditioning device according to the first aspect may further include a control unit configured to switch between a first state and a second state. Here, the first state is a state in which the first damper opens the first communication path and the second damper closes the rear-side duct. The second state is a state in which the first damper closes the first communication path and the second damper opens the rear-side duct.

In the second aspect, operation of the first damper and the second damper is controlled by the control unit, and the first state in which an airflow is prevented from flowing into the rear side of the vehicle cabin and the second state in which an airflow is caused to flow into the rear side of the vehicle cabin can be automatically switched. A dead space is not generated in the rear-side flow passage section, and a pressure loss, which may be caused due to such a dead space, is not caused. Thus, air conditioning can be efficiently implemented in the entire vehicle cabin, irrespective of whether or not air is supplied to the rear side of the vehicle cabin, and whether or not a temperature is adjusted.

According to a third aspect of the present invention, the vehicle air-conditioning device according to the second aspect may further include a rear-side setting input unit for setting a temperature on the rear side of the vehicle cabin. In the second state, the control unit may control operation of the second damper based on an input of the rear-side setting input unit, and adjust a degree of opening of each of the downstream opening of the heater core and the second communication path.

In the third aspect, in the second state in which air is supplied to the rear side of the vehicle cabin, operation of the second damper is controlled by the control unit, based on an input of the rear-side setting input unit. In this manner, a degree of opening of each of the downstream opening of the heater core and the second communication path is adjusted. Therefore, a balance between warm air from the downstream opening of the heater core and cool air from the second communication path is adjusted, enabling temperature control of an airflow to be supplied to the rear side of the vehicle cabin. As a result, a comfortable vehicle cabin space can be provided on the rear side of the vehicle cabin.

According to a fourth aspect of the present invention, the vehicle air-conditioning device according to any one of the second and third aspects may further include a rear seat occupant detection unit configured to detect presence or absence of an occupant on a rear seat. The control unit may control operation of the first damper and the second damper, based on a detection result of the rear seat occupant detection unit, and switch between the first state and the second state.

In the fourth aspect, the first state in which an airflow is prevented from flowing into the rear side of the vehicle cabin and the second state in which an airflow is caused to flow into the rear side of the vehicle cabin can be automatically switched based on a detection result of the rear seat occupant detection unit. As a result, whether or not a flow of temperature-adjusted air is supplied to the rear side of the vehicle cabin can be automatically determined, depending on presence or absence of an occupant on a rear seat.

According to a fifth aspect of the present invention, the vehicle air-conditioning device according to any one of the second to fourth aspects may further include a rear-side temperature detection unit configured to detect a temperature on the rear side of the vehicle cabin. The control unit may control operation of the first damper, based on a detection result of the rear-side temperature detection unit, and switch between the first state and the second state.

In the fifth aspect, the first state in which an airflow is prevented from flowing into the rear side of the vehicle cabin and the second state in which an airflow is caused to flow into the rear side of the vehicle cabin can be automatically switched based on a detection result of the rear-side temperature detection unit. As a result, presence or absence of an occupant on a rear seat is determined based on a detection result of the rear-side temperature detection unit, and whether or not a flow of temperature-adjusted air is supplied to the rear side of the vehicle cabin can be automatically determined.

### Advantageous Effect of Invention

According to the above-described vehicle air-conditioning device, air conditioning can be efficiently implemented in the entire vehicle cabin.

### BRIEF DESCRIPTION OF DRAWINGS

FIG. 1 is an overall schematic perspective view of a vehicle air-conditioning device according to an embodiment of the present invention.

FIG. 2 is a vertical cross-sectional view illustrating a rear-side flow passage section of the vehicle air-conditioning device according to the embodiment of the present invention, which illustrates a first state in which a rear-side duct is closed.

FIG. 3 is a schematic cross-sectional diagram illustrating an airflow passage on a downstream side of a heater core of the vehicle air-conditioning device according to the embodiment of the present invention, and is a cross-sectional view taken along the line A-A in FIG. 2.

FIG. 4 is a vertical cross-sectional view illustrating the rear-side flow passage section of the vehicle air-conditioning device according to the embodiment of the present invention, which illustrates a second state in which the rear-side duct is opened.

### DESCRIPTION OF EMBODIMENTS

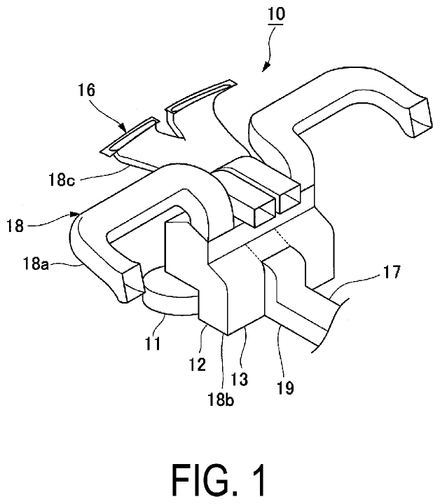

In the following, with reference to FIG. 1 to FIG. 4, a vehicle air-conditioning device 10 according to an embodiment of the present invention will be described.

The vehicle air-conditioning device 10 is disposed at a substantially center part on a front side of a vehicle in a vehicle width direction. As illustrated in FIG. 1 to FIG. 3, the vehicle air-conditioning device 10 integrally includes an air introduction unit 11 for introducing air, such as a blower unit, a heat exchange unit 12 that performs heat exchange with a flow of introduced air, and an airflow passage 13 continuously provided from the inside of the heat exchange unit 12 toward various parts in the vehicle cabin.

The heat exchange unit 12 includes an evaporator 14, and a heater core 15 disposed on a downstream side of the evaporator 14, in a casing 40.

A refrigerant is circulated between the evaporator 14 and a radiator (not illustrated), for example. The evaporator 14 is configured to cool air introduced into the vehicle air-conditioning device 10 to generate cool air.

In the heater core 15, a cooling fluid for an engine is circulated. The heater core 15 heats cool air from the evaporator 14 to generate warm air.

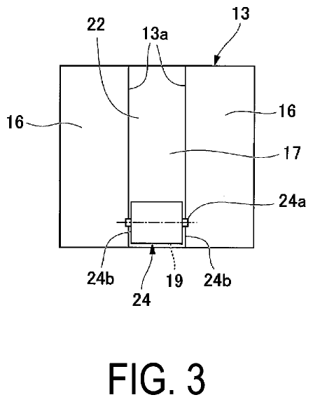

As illustrated in FIG. 3, in the casing 40, the airflow passage 13 is partitioned into a plurality of sections in the vehicle width direction by partition walls 13a. The airflow passage 13 is continuous from the inside of the heat exchange unit 12. The airflow passage 13 is disposed in such a manner that an airflow, which is a mixture of cool air from the evaporator 14 and warm air from the heater core 15, is blown out to various parts in the vehicle cabin.

The airflow passage 13 according to the present embodiment includes front-side flow passage sections 16 on the right and left sides to guide an airflow to a front side of a vehicle cabin, and a rear-side flow passage section 17 provided between these front-side flow passage sections 16 to blow out an airflow to a rear side of the vehicle cabin.

Each front-side flow passage section 16 includes a front-side duct 18, which includes a front face part 18a, a front foot part 18b, and a defroster part 18c, for example.

The rear-side flow passage section 17 includes an internal flow passage 20 of the heat exchange unit 12, a rear-side duct 19, a first communication path 21, a second communication path 22, a first damper 23, and a second damper 24. The internal flow passage 20 of the heat exchange unit 12 is provided on a downstream side of the evaporator 14 and an upstream side and a downstream side of the heater core 15. The rear-side duct 19, the first communication path 21, and the second communication path 22 are connected to the internal flow passage 20. The first damper 23 is disposed in the internal flow passage 20. The second damper 24 is provided independently of the first damper 23.

The internal flow passage 20 branches from a downstream side of the evaporator 14. The internal flow passage 20 can allow a part of an airflow from the evaporator 14 to flow to an upstream opening 15a side of the heater core 15, and can allow the remaining flow of air to flow to the first communication path 21 and the second communication path 22 side. A downstream opening 15b is provided on a downstream side of the heater core 15. The downstream opening 15b can allow an airflow from the heater core 15 to flow out of the downstream opening 15b.

At some parts of the internal flow passage 20, a damper for changing a cross-sectional area of a flow passage, and a damper for mixing cool air and warm air or for adjusting a ratio of cool air and warm air, for example, may be provided.

The rear-side duct 19 is provided to extend from a downstream side of the heater core 15 to the rear side of the vehicle cabin. On the rear side of the vehicle cabin, a rear face part and a rear foot part, for example, are provided in a branching manner. However, detailed illustration of such parts is omitted.

The first communication path 21 communicates the internal flow passage 20 on a downstream side of the evaporator 14 and the front-side duct 18 of the front-side flow passage section 16 with each other.

The first damper 23 is provided at an inlet of the first communication path 21. Through opening and closing operation of the first damper 23, the first communication path 21 can be opened and closed. The first damper 23 according to the present embodiment is a butterfly damper, for example. The first damper 23 is provided to be rotatable about a shaft 23a extending in the vehicle width direction, and is configured to be operable by a drive unit (not illustrated).

The second communication path 22 is a path communicating the internal flow passage 20 on a downstream side of the evaporator 14 and the downstream opening 15b on a downstream side of the heater core 15 with each other.

The second damper 24 is provided at a position between one end portion of the second communication path 22 (downstream end portion of the heater core 15), the downstream opening 15b of the heater core 15, and an upstream end portion of the rear-side duct 19. The second communication path 22, the downstream opening 15b, and the rear-side duct 19 can communicate with each other through the second damper 24. The second damper 24 according to the present embodiment is a rotary damper, for example. Further, as illustrated in FIG. 3, the second damper 24 includes a shaft 24a extending in the vehicle width direction, and a support piece 24b connected to the shaft 24a and having a shape of a circular sector when seen from the vehicle width direction.

The second damper 24 is configured to be rotatable about the shaft 24a by a drive unit (not illustrated). The second damper 24 can change a communication state between the second communication path 22, the downstream opening 15b of the heater core 15, and the rear-side duct 19, depending on a rotation angle of the second damper 24.

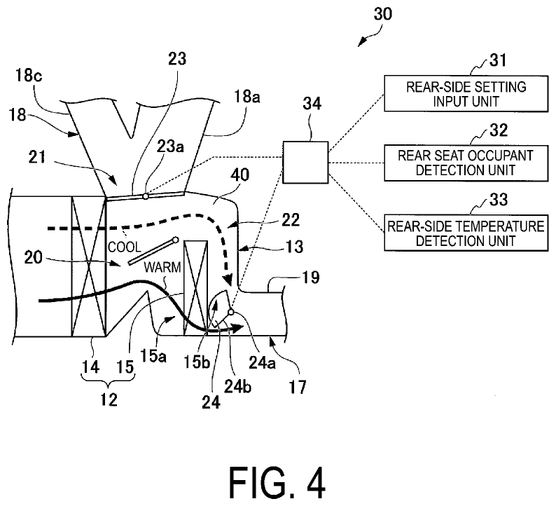

For example, when the support piece 24b is rotated about the shaft 24a, the rear-side duct 19 is closed as illustrated in FIG. 3, or the rear-side duct 19 is opened as illustrated in FIG. 4. In this manner, a rate of a degree of opening between the downstream opening 15b of the heater core 15 and the second communication path 22 can be adjusted. The second damper can be rotated 360 degrees. Therefore, in addition to the above, the second damper can adjust a degree of opening of various parts to open and close such parts, depending on a position of the support piece 24b of the second damper 24.

The vehicle air-conditioning device 10 is provided with a control system 30 for optimizing a blow of an airflow into the vehicle cabin.

The control system 30 according to the present embodiment includes a rear-side setting input unit 31, a rear seat occupant detection unit 32, a rear-side temperature detection unit 33, and a control unit 34. The rear-side setting input unit 31 is an input unit for setting a temperature on the rear side of the vehicle cabin. The rear seat occupant detection unit 32 detects presence or absence of an occupant on a rear seat. The rear-side temperature detection unit 33 detects a temperature on the rear side of the vehicle cabin. The control unit 34 controls operation of the drive units (not illustrated) of the first damper 23 and the second damper 24.

With the rear-side setting input unit 31, a setting temperature on the rear side of the vehicle cabin can be input. An occupant may use the rear-side setting input unit 31 to set a specific temperature on the rear side of the vehicle cabin, or may select one of preset temperatures (modes).

The rear seat occupant detection unit 32 is only required to be able to detect presence or absence of an occupant on a rear seat. The rear seat occupant detection unit 32 may be an IR sensor (human detection sensor) such as an infrared sensor, or a pressure sensor that detects seating of an occupant on a rear seat, for example.

The rear-side temperature detection unit 33 is a temperature sensor that detects a temperature around an occupant seated on a rear seat, for example.

The control unit 34 includes an MPU, for example. The control unit 34 controls operation of the first damper 23 and the second damper 24, based on a temperature set value that is set in the rear-side setting input unit 31, presence or absence of an occupant as detected by the rear seat occupant detection unit 32, and a temperature on the rear side of the vehicle cabin as detected by the rear-side temperature detection unit 33.

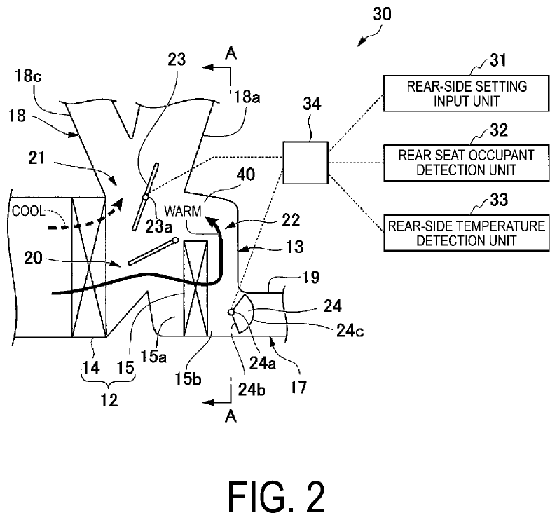

The control unit 34 can switch between a first state (see FIG. 2) and a second state (see FIG. 4) by controlling operation of the first damper 23 and the second damper 24. Here, the first state is a state in which the first communication path 21 is opened by the first damper 23, and the rear-side duct 19 is closed by the second damper 24. The second state is a state in which the first damper 23 closes the first communication path 21, and the rear-side duct 19 is opened by the second damper 24.

Next, a procedure of control performed by the control unit 34 will be described.

When a desired temperature is set by the rear-side setting input unit 31 after an occupant seated on a rear seat is detected by the rear seat occupant detection unit 32, the control unit 34 of the vehicle air-conditioning device 10 controls operation of the first damper 23 and the second damper 24. Further, when the control unit 34 of the vehicle air-conditioning device 10 implements air conditioning of the vehicle cabin after an occupant seated on a rear seat is detected by the rear seat occupant detection unit 32 and a desired temperature is set by the rear-side setting input unit 31, the control unit 34 of the vehicle air-conditioning device 10 controls operation of the first damper 23 and the second damper 24.

In this control, a state is switched to the second state (see FIG. 4), in which the first damper 23 is closed and the second damper 24 is opened. Further, in the above-described control, a rate of a degree of opening between a degree of opening of the downstream opening 15b of the heater core 15 and a degree of opening of the second communication path 22 is adjusted by the second damper 24, based on a difference between a temperature set in the rear-side setting input unit 31 and a temperature detected by the rear-side temperature detection unit 33.

In this manner, an airflow, which includes warm air from the heater core 15 and cool air supplied from the evaporator 14 supplied through the second communication path 22 mixed according to a rate of a degree of opening, is blown out to the rear side of the vehicle cabin through the rear-side duct 19.

For example, when a difference between a temperature set in the rear-side setting input unit 31 and a temperature detected by the rear-side temperature detection unit 33 is so large as to be equal to or more than a predetermined value, the control unit 34 causes the second damper 24 to further operate to change a mixing rate of cool air and warm air.

Next, when the rear seat occupant detection unit 32 detects a case of absence of an occupant on a rear seat, or air conditioning on the rear side of the vehicle cabin is not implemented, the control unit 34 fully closes the rear-side duct 19 with the second damper 24. In this case, a state is switched to the first state (see FIG. 2), in which the first damper 23 fully opens the first communication path 21. As a result, a downstream side of the evaporator 14 communicates with the front-side duct 18 through the first communication path 21.

Consequently, in the rear-side flow passage section 17, each of cool air from a downstream side of the evaporator 14 and warm air partly extracted from the cool air and then heated by the heater core 15 to flow through the second communication path 22 can be caused to reach the first communication path 21, and can be caused to flow into the front-side flow passage sections 16. Such cool air and warm air are blown out to the front side of the vehicle cabin through the front-side duct 18, together with other flows of air flowing through the front-side flow passage sections 16.

According to the vehicle air-conditioning device 10 of the present embodiment, the first damper 23 that opens and closes the first communication path 21, and the second damper 24 that changes a communication state between the downstream opening 15b of the heater core 15, the rear-side duct 19, and the second communication path 22 are included. Therefore, in the second state, when the first communication path 21 is closed by the first damper 23 and a degree of opening of the downstream opening 15b of the heater core 15, a degree of opening of the rear-side duct 19, and a degree of opening of the second communication path 22 are adjusted by the second damper 24, an airflow being a mixture of cool air and warm air can be blown out to the rear side of the vehicle cabin through the rear-side duct 19.

In this case, when a degree of opening of the downstream opening 15b of the heater core 15 and a degree of opening of the second communication path 22 are adjusted by the second damper 24, a temperature of an airflow to flow to the rear side of the vehicle cabin can be adjusted independently of an airflow to be blown out to the front side of the vehicle cabin.

In contrast, as the first state, the rear-side duct 19 is fully closed by the second damper 24, a blow of an airflow out to the rear side of the vehicle cabin is stopped, and the first communication path 21 is fully opened by the first damper 23. In this manner, an airflow heat-exchanged in the heater core 15 can be caused to flow into the front-side flow passage sections 16. Therefore, even when a blow of an airflow out to the rear side of the vehicle cabin is stopped, a dead space is not generated in the casing 40, and a pressure loss, which may be caused due to such a dead space, is not caused.

As a result, a significant change in a flow rate of a flow of temperature-adjusted air in the entire vehicle cabin can be prevented. Specifically, even when a blow of an airflow out to the rear side of the vehicle cabin is stopped, a flow rate and heat of the flow of air can be blown out to the front side of the vehicle cabin. Therefore, according to the present embodiment, whether or not temperature control of an airflow on the rear side of the vehicle cabin is performed and whether or not air is supplied to the rear side of the vehicle can be switched. In addition, air conditioning can be efficiently implemented in the entire vehicle cabin, irrespective of whether or not temperature control of an airflow on the rear side of the vehicle cabin is performed and whether or not air is supplied to the rear side of the vehicle.

According to the present embodiment, the control unit 34 controls operation of the second damper 24, based on an input of the rear-side setting input unit 31. In this manner, a mixing rate of warm air and cool air can be changed, and thus, a temperature on the rear side of the vehicle cabin can be automatically adjusted. As a result, a comfortable vehicle cabin space can be provided on the rear side of the vehicle cabin.

According to the present embodiment, the control unit 34 adjusts a degree of opening of the second damper 24, based on a detection result of the rear seat occupant detection unit 32. Therefore, the rear-side duct 19 can be automatically opened and closed, depending on presence or absence of an occupant on a rear seat. As a result, whether or not a flow of temperature-adjusted air is supplied to the rear side of the vehicle cabin can be automatically determined.

According to the present embodiment, presence or absence of an occupant on a rear seat is determined based on a detection result of the rear-side temperature detection unit 33, and whether or not a flow of temperature-adjusted air is supplied to the rear side of the vehicle cabin can be automatically determined.

The embodiment of the present invention has been described above in detail with reference to the drawings, but the specific configurations are not limited to those embodiments, and design changes and the like that do not depart from the scope of the present invention are also included.

For example, the above description gives an example in which the control unit 34 controls operation of the first damper 23 and the second damper 24, based on a temperature set value that is set in the rear-side setting input unit 31, presence or absence of an occupant as detected by the rear seat occupant detection unit 32, and a temperature on the rear side as detected by the rear-side temperature detection unit 33. However, a control method is not specifically limited to such a control method, and may be selected as appropriate.

For example, at least one of the rear-side setting input unit 31, the rear seat occupant detection unit 32, and the rear-side temperature detection unit 33 may be provided. Further, another state variable may be detected to perform control.

In the embodiment described above, the rear-side flow passage section 17 is provided between a pair of front-side flow passage sections 16. However, conversely, the front-side flow passage section 16 may be provided between a pair of rear-side flow passage sections 17. The positions and the shapes of the front-side flow passage section 16 and the rear-side flow passage section 17 are not specifically limited.

### INDUSTRIAL APPLICABILITY

The present invention can be applied to a vehicle air-conditioning device. According to the present invention, air conditioning can be efficiently implemented in the entire vehicle cabin.

### REFERENCE SIGNS LIST

10 Vehicle air-conditioning device
11 Air introduction unit
12 Heat exchange unit
13 Airflow passage
13a Partition wall
14 Evaporator
15 Heater core
15a Upstream opening
15b Downstream opening
16 Front-side flow passage section
17 Rear-side flow passage section
18 Front-side duct
18a Front face part
18b Front foot part
18c Defroster part
19 Rear-side duct
20 Internal flow passage
21 First communication path
22 Second communication path
23 First damper
23a Shaft
24 Second damper
24a Shaft
24b Support piece
30 Control system
31 Rear-side setting input unit
32 Rear seat occupant detection unit
33 Rear-side temperature detection unit
34 Control unit
40 Casing

1. A vehicle air-conditioning device comprising:
an evaporator;
a heater core disposed on a downstream side of the evaporator; and
a front-side flow passage section and a rear-side flow passage section, the front-side flow passage section being configured to allow an airflow to be blown out to a front side of a vehicle cabin, the flow of air including both cool air from the evaporator and warm air from the heater core, the rear-side flow passage section being provided independently of the front-side flow passage section and being configured to allow the flow of air to be blown out to a rear side of the vehicle cabin, wherein
the rear-side flow passage section includes:
a rear-side duct extending from a downstream side of the heater core to the rear side of the vehicle cabin;
a first communication path communicating a downstream side of the evaporator and the front-side flow passage section with each other;
a second communication path communicating a downstream side of the evaporator and a downstream side of the heater core with each other;
a first damper configured to open and close the first communication path to allow an airflow to be selectively introduced into the first communication path or the second communication path; and
a second damper configured to change a communication state between a downstream opening of the heater core, the rear-side duct, and the second communication path.

2. The vehicle air-conditioning device according to claim 1, further comprising
a control unit configured to switch between a first state and a second state, the first state being a state in which the first damper opens the first communication path and the second damper closes the rear-side duct, the second state being a state in which the first damper closes the first communication path and the second damper opens the rear-side duct.

3. The vehicle air-conditioning device according to claim 2, further comprising
a rear-side setting input unit for setting a temperature on the rear side of the vehicle cabin, wherein
in the second state, the control unit controls operation of the second damper, based on an input of the rear-side setting input unit, and adjusts a degree of opening of each of the downstream opening of the heater core and the second communication path.

4. The vehicle air-conditioning device according to claim 2, further comprising
a rear seat occupant detection unit configured to detect presence or absence of an occupant on a rear seat, wherein
the control unit controls operation of the first damper and the second damper, based on a detection result of the rear seat occupant detection unit, and switches between the first state and the second state.

5. The vehicle air-conditioning device according to claim 2, further comprising
a rear-side temperature detection unit configured to detect a temperature on the rear side of the vehicle cabin, wherein
the control unit controls operation of the first damper, based on a detection result of the rear-side temperature detection unit, and switches between the first state and the second state.

6. The vehicle air-conditioning device according to claim 3, further comprising
a rear seat occupant detection unit configured to detect presence or absence of an occupant on a rear seat, wherein
the control unit controls operation of the first damper and the second damper, based on a detection result of the rear seat occupant detection unit, and switches between the first state and the second state.

7. The vehicle air-conditioning device according to claim 3, further comprising
a rear-side temperature detection unit configured to detect a temperature on the rear side of the vehicle cabin, wherein
the control unit controls operation of the first damper, based on a detection result of the rear-side temperature detection unit, and switches between the first state and the second state.

8. The vehicle air-conditioning device according to claim 4, further comprising
a rear-side temperature detection unit configured to detect a temperature on the rear side of the vehicle cabin, wherein
the control unit controls operation of the first damper, based on a detection result of the rear-side temperature detection unit, and switches between the first state and the second state.
